(19) United States
(12) Patent Application Publication
(10) Pub. No.: US 2009/0152499 A1
(43) Pub. Date: Jun. 18, 2009

(54) Method for the production of olefins and synthesis gas

(75) Inventors: Bernd Bartenbach, Limburgerhof (DE); Julian Prölß, Worms (DE); Petra Schmitz-Bäder, Frankenthal (DE); Christian Weichert, Bad Dürkheim (DE); Kai Rainer Ehrhardt, Ludwigshafen (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/587,305

(22) PCT Filed: Apr. 21, 2005
(86) PCT No.: PCT/EP2005/004307

§ 371 Date: Oct. 23, 2006

(30) Foreign Application Priority Data
Apr. 22, 2004 (DE) 10 2004 019 649.4

(51) Int. Cl. C01B 3/24

(52) U.S. Cl. 252/373; 585/324; 585/319

(57) ABSTRACT

Methods comprising: (a) providing a starting mixture comprising at least one hydrocarbon and at least one oxygen source, wherein the starting mixture has a fuel number of at least 4; (b) heating the starting mixture to a temperature of not more than 1400° C. and subjecting it to a single-stage, autothermal, uncatalyzed reaction to form a reaction gas; and (c) subjecting the reaction gas to rapid cooling to form at least one olefin and synthesis gas are described.

The present invention relates to a process for simultaneously preparing at least one olefin, optionally at least one additional unsaturated hydrocarbon other than an olefin and synthesis gas.

It is known that olefins can be prepared by subjecting saturated aliphatic hydrocarbons (paraffins) and mixtures thereof to a catalytically induced, autothermal, oxidative dehydrogenation. Thus, A. Beretta et al. in Chem. Eng. Sci. 56 (2001), 779-787, describe the influence of a heterogeneous catalyst in the high-temperature preparation of ethene. Furthermore, in J. Catal. 184 (1999), 455-468 A. Beretta et al. describe the influence of a Pt/Al₂O₃ catalyst on the oxidative dehydrogenation of propane in a tube reactor, and in J. Catal. 184 (1999), 469-478, A. Beretta et al. describe the preparation of olefins by platinum-catalyzed oxidative dehydrogenation of propane under autothermal conditions.

In J. Phys. Chem. 97 (1993), 11815-11822, M. Huff et al. describe the preparation of ethene by oxidative dehydrogenation of ethane, and in J. Catal. 149 (1994), 127-141, M. Huff et al. describe the preparation of olefins by oxidative dehydrogenation of propane and butane. The reaction is in each case carried out over catalyst monoliths coated with Pt, Rh or Pd.

WO 00/14180 describes a process for preparing olefins, in which paraffins are reacted with oxygen in the presence of a monolithic catalyst based on a metal of transition group VIII under autothermal conditions.

In Science 285 (1999), 712-715, A. S. Bodke et al. report an increase in the selectivity of the partial oxidation of ethane to ethene as a result of addition of hydrogen to the reaction mixture. The reaction is carried out in the presence of a platinum-tin catalyst.

WO 01/14035 describes a process for preparing olefins in which paraffins or paraffin mixtures are reacted with oxygen in the presence of hydrogen and a catalyst based on a metal of transition group VIII under autothermal conditions.

In the abovementioned documents, the presence of a heterogeneous catalyst is regarded as indispensable for a successful autothermal preparation of olefins, regardless of the assumed mechanism of the gas-phase reaction.

It is known that acetylene can be prepared in uncatalyzed processes which are based on the pyrolysis or partial oxidation of hydrocarbons. Starting substances used here can be, for example, natural gas, various petroleum fractions (e.g. naphtha) and even oil residues (immersed flame process). In pyrolytic or oxidative processes for preparing acetylene, thermodynamic and kinetic parameters have in principle a critical influence on the choice of reaction conditions. Important prerequisites of such processes are generally rapid introduction of energy, short residence times of the starting materials and reaction products, low partial pressure of the acetylene and rapid quenching of the gases formed. Thus, for example, EP-A-1 041 037 describes a process for preparing acetylene and synthesis gas by thermal treatment of a starting mixture comprising one or more hydrocarbons together with an oxygen source, with the starting mixture being heated to a maximum of 1400° C., reacted in a reactor and subsequently cooled.

The preparation of olefins in uncatalyzed high-temperature processes is also known. In Petrol. Refiner, 29 (September 1950), 217, R. M. Deanesly describes the autothermal cracking of hydrocarbon streams to produce ethene. Here, the reaction gases are passed through heat exchangers in which the feed streams are preheated.

In Petrol. Refiner, 35, No. 7, pp. 179-182, R. L. Mitchel describes the mechanism of the uncatalyzed gas-phase oxidation of hydrocarbons and the influence of various parameters on this reaction. This article is essentially concerned with oxidation to form alcohols, aldehydes, etc. The aspect of oxidative dehydrogenation is only addressed marginally and a maximum yield for the formation of olefins, specifically ethene and propene, in a temperature range from 700 to 800° C. is reported.

WO 00/06948 describes a process for utilizing a hydrocarbon-containing fuel with use of an exothermic prereaction in the form of a “cold flame”.

WO 00/15587 describes a process for preparing monoolefins and synthesis gas by oxidative dehydrogenation of gaseous paraffinic hydrocarbons by autothermal cracking of ethane, propane and butanes. The reaction can be carried out in the presence or absence of a catalyst, but the use of a catalyst for the reaction of fuel-rich, nonignitable mixtures is taught.

GB-A-794,157 describes a process for preparing acetylene and ethylene by partial combustion of methane and/or ethane in two successive reaction zones, with the first reaction zone being operated at a pressure above atmospheric pressure and the second being operated at a lower pressure.

GB-A-659,616 describes a process for the oxidative cracking of nonaromatic hydrocarbon streams, in which these are preheated to a temperature in the range from 540 to 870° C., mixed with an oxygen-containing gas which has likewise been preheated to a temperature in this range and the mixture is subsequently subjected to a partial combustion. The preheating temperature is above the spontaneous ignition temperature of the mixture. The oxygen content is in the range from 10 to 35% based on the hydrocarbon used. The reaction zone employed is designed to generate turbulent flow of the reaction gases, so that mixing of combustion gases with fresh fuel is made to occur in the reaction zone in this process.

GB-A-945,448 describes a process for preparing olefins from saturated aliphatic hydrocarbon streams by reaction with oxygen at temperatures of less than 700° C. The temperature is nevertheless above the spontaneous ignition temperature. The ratio of hydrocarbon starting material to oxygen in the reaction is greater than about 2:1. The reactants used are mixed in a mixing zone with generation of turbulence, with the resulting turbulent flow being able to continue into the reaction zone. Mixing of combustion gases with fresh fuel in the reaction zone can thus occur in this process, too.

U.S. Pat. No. 3,095,293 describes a process for preparing ethene by incomplete combustion of naphtha in the presence of steam. In this process, acetylene and CO₂ are firstly removed from the reaction gas by absorption processes, the reaction gas is subsequently passed to a plurality of cooling steps in heat exchangers and partially condensed, ethene is isolated as main product from the condensate and the uncondensed fraction is burnt, with the heat evolved being utilized for generating the steam. As regards the combustion apparatus used, reference is made to U.S. Pat. No. 2,750,434.

U.S. Pat. No. 2,750,434 describes a process for converting hydrocarbons into unsaturated hydrocarbons, aromatic hydrocarbons and acetylene. For this purpose, the hydrocarbons are subjected to a cracking process at high temperatures in the range from about 700 to 1900° C. and short reaction times in the millisecond range. The reaction is carried out in a tangential reactor with a permanent pilot flame which produces the hot combustion gases brought into contact with the hydrocarbon fed in. The process thus involves initially a separate combustion in the pilot flame and subsequently the further reaction of the feed hydrocarbons in the presence of the combustion gases in a subsequent stage.

It is an object of the present invention to provide a process for simultaneously preparing olefins and further economically interesting coproducts. In this process, hydrocarbon feedstocks available in petrochemical complexes should preferably be used, and, in particular, use of higher alkanes and aromatics-rich hydrocarbon mixtures should also be possible.

It has surprisingly been found that this object can be achieved by a process in which very fuel-rich (rich) starting hydrocarbon mixtures are subjected to a single-stage, autothermal, uncatalyzed reaction at relatively low temperatures (≦1400° C.).

The present invention accordingly provides a process for simultaneously preparing at least one olefin and synthesis gas, which comprises
a) providing a starting mixture comprising at least one hydrocarbon and at least one oxygen source, with the fuel number of the mixture being at least 4,
b) heating the starting mixture to a temperature of not more than 1400° C. and subjecting it to a single-stage, autothermal, uncatalyzed reaction at this temperature in a reaction zone,
c) subjecting the reaction gas obtained in step b) to rapid cooling.

For the purposes of the present invention, the fuel number is defined as the stoichiometric ratio of the oxygen required for complete combustion of the hydrocarbon present in the starting mixture used to the oxygen available for combustion. According to a general definition, the fuel number corresponds to the reciprocal of the air number. The fuel number of the starting mixture is preferably at least 5.

For the purposes of the present invention, an autothermal reaction is a reaction in which the heat energy required results from partial combustion of a starting material.

According to the invention, the autothermal reaction of the starting mixture is carried out in a single stage. Here, the term “single stage” is to be interpreted both macroscopically and microscopically. Single-stage reactions do not include those in which the reaction occurs successively in a plurality of reaction zones. Single-stage reactions also do not include those in which the reaction occurs in a plurality of stages in a single reaction zone. This is, for example, the case when part of the starting hydrocarbon is initially burnt and a further part is reacted in the form of a mixture with the hot reaction gases resulting from this combustion. For the purposes of the invention, “single-stage” thus also means “without a separate prereaction”. This does not apply, as an exceptional case, to preheating of the starting mixture in an exothermic prereaction in the form of a “cold flame”, as is described in WO 00/06948. This form of preheating should be permitted in the process of the invention, but does not represent a preferred embodiment.

The single-stage process of the invention preferably comprises essentially complete mixing of the hydrocarbon used and the oxygen source prior to the autothermal reaction.

Suitable apparatus for implementing a single-stage reaction are described in detail below. In general, the reaction zone is configured as a system with low backmixing. This preferably has essentially no macroscopic mass transfer in the direction opposite to the flow direction.

Furthermore, according to the invention the autothermal reaction of the starting mixture occurs noncatalytically, i.e. in the absence of catalysts as are described in the prior art for, for example, the oxidative dehydrogenation of saturated hydrocarbons.

The process of the present invention is employed for the simultaneous preparation of a plurality of products of value. Preference is given to at least one olefin selected from among ethene and propene being obtained. In addition, further higher olefins such as butenes, pentenes, etc., can be obtained.

Further products of value obtained in the process of the invention are hydrogen and carbon monoxide, which can be isolated as a mixture (known as synthesis gas). Synthesis gas is an important C₁ building block which has many uses (oxo process, Fischer-Tropsch synthesis, etc.).

In addition, further unsaturated hydrocarbons can be obtained as products of value in the process of the invention. These are preferably selected from among alkynes, in particular acetylene (ethyne), aromatics, in particular benzene, and mixtures thereof. In a specific embodiment, the process is useful for at least partial dealkylation of alkylated aromatics, e.g. BTX fractions. Further products of value which can be obtained are, for example, short-chain alkanes such as methane. Suitable embodiments of the process for obtaining at least one of the abovementioned additional products are described in detail below.

The process of the invention makes it possible to prepare the abovementioned products of value, in particular olefins, from a large number of different starting hydrocarbons and hydrocarbon mixtures. The composition of the reaction gas can be controlled, inter alia, by means of the following parameters:
composition of the starting mixture (type and amount of hydrocarbons, type and amount of oxygen source, additional components) and
reaction conditions in the autothermal, uncatalyzed reaction (reaction temperature, residence time, introduction of reactants into the reaction zone).

### Step a)

A fuel-rich (rich) starting mixture is provided for the reaction. The fuel number at the time of initiation of the autothermal reaction is preferably at least 5, particularly preferably at least 6.5 and in particular at least 9.

The hydrocarbon provided in step a) is preferably selected from among alkanes, aromatics and alkane- and/or aromatic-containing hydrocarbon mixtures. Hydrocarbon mixtures can in principle contain the individual components in any amounts. In the case of mixtures comprising at least one alkane and at least one aromatic, either alkanes or aromatics can be present in excess. Suitable alkanes are, for example, low molecular weight C₁-C₄-alkanes which are gaseous under normal conditions (methane, ethane, propanes, butanes) and also relatively high molecular weight alkanes which are liquid or solid under normal conditions, for example C₅-C₃₀-alkanes (pentanes, hexanes, heptanes, octanes, nonanes, etc.). Suitable aromatics are, for example, benzene, fused aromatics such as naphthalene and anthracene and their derivatives. These include, for example, alkylbenzenes such as toluene, o-, m- and p-xylene and ethyl benzene.

The hydrocarbons are preferably used in the form of a natural or industrially available hydrocarbon mixture in step a). These mixtures are preferably selected from among natural gases, liquefied gases (propane, butane, etc), light petroleum spirit, pyrolysis gasoline and mixtures thereof. The hydrocarbon mixture is preferably selected from among light petroleum spirit, pyrolysis gasoline and fractions and subsequent products of pyrolysis gasoline and mixtures thereof. Pyrolysis gasoline is obtained in steam cracking of naphtha and has a high aromatics content. Preferred downstream products of pyrolysis gasoline are its (partial) hydrogenation products. A further preferred mixture of aromatics is the BTX aromatics fraction which consists essentially of benzene, toluene and xylenes.

To prepare product mixtures which have high proportions of olefins, in particular of ethene and/or propene, preference is given to using hydrocarbons which consist of at least one alkane or have a high alkane content.

To prepare product mixtures having a high proportion of nonalkylated aromatics (e.g. benzene) or aromatics having low proportions of alkyl substituents, preference is given to using hydrocarbons which consist of alkylaromatics or have a high proportion of alkylaromatics. These are subjected to partial or complete dealkylation under the conditions of the autothermal, noncatalyzed reaction according to the invention.

The oxygen source used in step a) is preferably selected from among molecular oxygen, oxygen-containing gas mixtures, oxygen-containing compounds and mixtures thereof. In a preferred embodiment, molecular oxygen is used as oxygen source. This makes it possible to keep the content of inert compounds in the starting mixture low. However, it is also possible to use air or air/oxygen mixtures as oxygen source. Oxygen-containing compounds used are, for example, water, preferably in the form of water vapor, and/or carbon dioxide. When carbon dioxide is used, this can be recycled carbon dioxide from the reaction gas obtained in the autothermal reaction.

The starting mixtures used in the process of the invention can comprise at least one further component in addition to the hydrocarbon component and the oxygen component. Such components include, for example, recirculated reaction gas and recycle gases from the fractionation of the reaction gas, e.g. hydrogen, crude synthesis gas, CO, CO₂ and unreacted starting materials, and also further gases to influence the yield of and/or selectivity to particular products, e.g. hydrogen.

### Step b)

Step b) of the process of the invention comprises in principle the following individual steps: if appropriate preheating of at least one component, if appropriate premixing at least part of the components, initiation of the autothermal reaction, autothermal reaction. Since the reaction in step b) is, according to the invention, carried out in one stage, preheating and/or premixing is carried out only under conditions which do not allow a separate prereaction. A sole exception is an exothermic prereaction in the form of a “cold flame”. With regard to preheating by means of a cold flame, the disclosure of WO 00/06948 is incorporated by reference.

In a first embodiment of the process of the invention, the starting mixture prepared in step a) is not additionally heated before being used in step b). In a second embodiment, the starting mixture prepared in step a) is heated to a temperature which is lower than the spontaneous ignition temperature of the mixture before being used in step b). As an alternative, heating is effected by means of an exothermic prereaction in the form of a cold flame.

Initiation of the autothermal reaction and autothermal reaction go over directly into one another.

The components forming the starting mixture can be partly or completely premixed prior to the reaction. Before, during or after premixing, part of the components or all components can be preheated. Gaseous components are preferably not preheated prior to initiation of the autothermal reaction. Liquid components are preferably vaporized and only then mixed with gaseous components or fed to the initiation stage of the autothermal reaction. A useful embodiment as apparatus utilizes reactors based on the “cold flame” concept when liquid components are used.

In the autothermal reaction, the starting mixture is heated to a temperature of not more than 1400° C. This can be achieved by introduction of energy and/or an exothermic reaction of the starting mixture. Initiation of the exothermic reaction can occur in the presence or absence of a catalyst. The initiation of the exothermic reaction, e.g. the autothermal reaction, is preferably effected in the absence of a catalyst. In a suitable embodiment, the starting mixture, which may have been preheated, is ignited, and this is followed directly by the autothermal reaction in the reaction zone.

Ignition of the starting mixture is effected in an apparatus suitable for this purpose. Such apparatuses include specific burners in which the starting mixture is reacted to form a flame.

The initiation of the autothermal reaction is followed by the reaction in at least one reaction zone under autothermal conditions. This reaction preferably occurs essentially adiabatically, i.e. essentially no heat exchange with the environment takes place. The heat of reaction liberated by partial combustion of the starting mixture effects the thermal treatment of the starting mixture so as to produce a product mixture according to the invention which comprises at least one olefin, if appropriate at least one unsaturated hydrocarbon other than an olefin and synthesis gas. The reaction types forming the basis of this reaction include combustion (total oxidation), partial combustion (partial oxidation or oxidative pyrolysis) and pyrolysis reactions (reactions without participation of oxygen).

The reaction in step b) preferably occurs at a temperature in the range from 600 to 1300° C., preferably from 800 to 1200° C.

The residence time of the reaction mixture in the reaction zone is preferably from 0.01 s to 1 s, particularly preferably from 0.02 s to 0.2 s.

The reaction for preparing the product mixture obtained according to the invention can, according to the process of the invention, be carried out at any pressure, preferably a pressure in the region of atmospheric pressure.

The apparatuses used for the reaction in step b) have to be suitable for carrying out a single-stage reaction. In general, the reaction zone is for this purpose configured as a system with low backmixing. This zone preferably has essentially no macroscopic mass transfer in the direction opposite the flow direction. The apparatus used in step b) preferably makes it possible for the autothermal reaction to be stabilized in a narrow flame front.

The components forming the starting mixture are preferably mixed completely prior to the reaction. If mixing is incomplete, losses in yield of the desired target compounds may sometimes occur.

In a useful embodiment as apparatus, the reaction zone is configured as a tube reactor.

The reaction in step b) can advantageously be carried out using a pore burner. Such burners are described, for example, in the thesis by K. Pickenecker, Universität Erlangen-Nümberg, VDI Fortschrittsberichte, Series 6, No. 445 (2000), which is hereby fully incorporated by reference. Furthermore, a premix burner lock as described in EP-A-1 182 181 can be advantageously used in step b). The disclosure of this document is likewise fully incorporated by reference.

### Step c)

The reaction of the reaction mixture in step b) is, according to the invention, followed by rapid cooling of the resulting reaction gases in step c). This can be carried out by direct cooling, indirect cooling or a combination of direct and indirect cooling. In the case of direct cooling (quenching), a coolant is brought into direct contact with the hot reaction gases in order to cool them. In the case of indirect cooling, heat energy is taken from the reaction gas without the latter coming into direct contact with a coolant. Preference is given to indirect cooling, since this generally makes effective utilization of the heat energy transferred to the coolant possible. For this purpose, the reaction gases can be brought into contact with the exchange surfaces of a customary heat exchanger. Suitable apparatuses are, for example, the heat recovering systems as are used in the Texaco gasification and in steam crackers. The heated coolant can, for example, be used for heating the starting materials in the process of the invention or in a different endothermic process. Furthermore, the heat taken from the reaction gases can also be used, for example, for generating steam. Combined use of direct cooling (prequench) and indirect cooling is also possible, with the reaction gas obtained in step c) preferably being cooled to a temperature of not more than 1000° C. by direct cooling (prequench). Direct cooling can, for example, be carried out by introduction of quenching oil, water, steam or cold recycle gases. When hydrocarbon compositions are used as quenching medium, cracking processes can be effected at the same time (cracking of the hydrocarbons present in the quenching medium).

### Step d)

To work up the reaction gas obtained in step c), it can be subjected to at least one fractionation and/or purification step d). To fractionate the reaction gas, it can, for example, be subjected to a fractional condensation or the liquefied reaction gases can be subjected to a fractional distillation. Suitable apparatuses and processes are known in principle to those skilled in the art. Individual components can be isolated from the reaction gas, for example by scrubbing with suitable liquids or can be obtained by fractional adsorption/desorption. In this way, it is possible, for example, to separate off alkynes, in particular acetylene, by means of an extractant, for example N-methylpyrrolidone or dimethylformamide.

As described above, the process of the invention makes it possible to prepare additional unsaturated hydrocarbons other than olefins.

In a specific embodiment of the process of the invention, at least one dealkylated aromatic, in particular benzene, is prepared. For this purpose, the starting mixture provided in step a) comprises at least one alkylaromatic. This starting mixture is then preferably selected from among pyrolysis gasoline and partially hydrogenated hydrolysis gasoline. A preferred mixture of aromatics is the BTX aromatics fraction. In this embodiment, the reaction in step b) is preferably carried out at a temperature in the range from 900 to 1250° C., preferably from 950 to 1150° C. The residence time of the reaction mixture in the reaction zone is preferably from 0.05 s to 1 s in this embodiment.

In a further specific embodiment of the process of the invention, at least one alkyne is prepared. For this purpose, the starting mixture provided in step a) comprises at least one alkane. In this embodiment, the reaction in step b) is preferably carried out at a temperature in the range from 1150 to 1400° C., preferably from 1250 to 1400° C. The residence time of the reaction mixture in the reaction zone is preferably from 0.01 s to 0.1 s in this embodiment.

The invention is illustrated by the following nonlimiting examples.

### EXAMPLES

The following examples were carried out in a tube reactor (ratio of length to diameter (L/D)=60) which was to a good approximation operated adiabatically. Liquid feed streams were prevaporized. All feed streams were fed into the reactor in premixed form. Initiation and stabilization of the autothermal reaction was ensured by use of a pore burner (foamed ceramic having a porosity of about 80%). The product gas was quenched by indirect cooling.

### Example 1

Partial oxidation of ethane in a gas mixture consisting of 61% by volume of ethane, 21% by volume of oxygen and 18% by volume of nitrogen gives ethylene in a molar carbon yield of 51% at an ethane conversion of 83%. The product gas further comprises methane, synthesis gas (CO and H₂), water vapor and nitrogen. In addition, small amounts of propane, CO₂ and soot are formed.

### Example 2

Partial oxidation of ethane (33% by volume of the raw gas) and xylene (12% by volume of the raw gas) by means of oxygen (24% by volume of the raw gas) with addition of water vapor (31 by volume of the raw gas) gives ethylene in a molar carbon yield of 23%. The yield of toluene is 4% and that of benzene is 19%. Further product gas components are methane, synthesis gas, water vapor and soot and small amounts of propene and CO₂.

### Example 3

Partial oxidation of octane (35% by volume of the raw gas) by means of oxygen (35% by volume of the raw gas) with addition of water vapor (30% by volume of the raw gas) gives ethylene in a molar carbon yield of 48%. The yield of propene is 12% and that of benzene is 4%. Further product gas components are methane, synthesis gas, water vapor and small amounts of ethyne, CO₂ and soot.

### Example 4

Partial oxidation of partially hydrogenated pyrolysis gasoline from a steam cracker (85% by volume of aromatics/15% by volume of aliphatics) by means of oxygen (16% by volume of the raw gas) in the presence of water vapor (40% by volume of the raw gas) gives ethylene in a molar carbon yield of 10% and benzene in a molar carbon yield of 33%. Further product gas components are methane, synthesis gas, water vapor, soot and small amounts of ethyne, toluene, xylene and CO₂.

1-25. (canceled)

26. A method comprising:
(a) providing a starting mixture comprising at least one hydrocarbon and at least one oxygen source, wherein the starting mixture has a fuel number of at least 4;
(b) heating the starting mixture to a temperature of not more than 1400° C. and subjecting it to a single-stage, autothermal, uncatalyzed reaction to form a reaction gas; and
(c) subjecting the reaction gas to rapid cooling to form at least one olefin and synthesis gas.

27. The method according to claim 26, wherein the starting mixture has a fuel number of at least 5.

28. The method according to claim 26, wherein the single-stage, autothermal, uncatalyzed reaction is carried out in a reaction zone with low backmixing.

29. The method according to claim 26, wherein the at least one hydrocarbon comprises a component selected from the group consisting of alkanes, aromatics and mixtures thereof.

30. The method according to claim 26, wherein the at least one hydrocarbon comprises a mixture of two or more hydrocarbons.

31. The method according to claim 26, wherein the at least one hydrocarbon comprises a component selected from the group consisting of natural gases, liquefied gases, petroleum fractions, petroleum pyrolysates and mixtures thereof.

32. The method according to claim 26, wherein the at least one hydrocarbon comprises a component selected from the group consisting of light petroleum spirit, pyrolysis gasoline and fractions and subsequent products of pyrolysis gasoline, and mixtures thereof.

33. The method according to claim 26, wherein the at least one oxygen source comprises a component selected from the group consisting of molecular oxygen, oxygen-containing gas mixtures, oxygen-containing compounds and mixtures thereof.

34. The method according to claim 26, wherein the at least one oxygen source comprises air or an air/oxygen mixture.

35. The method according to claim 26, wherein the at least one oxygen source comprises a component selected from the group consisting of water vapor, carbon dioxide or mixtures thereof.

36. The method according to claim 26, wherein the starting mixture is heated to a temperature which is lower than the spontaneous ignition temperature of the starting mixture prior to heating to a temperature of not more than 1400° C.

37. The method according to claim 26, wherein heating the starting mixture to a temperature of not more than 1400° C. comprises an exothermic prereaction.

38. The method according to claim 26, wherein the single-stage, autothermal, uncatalyzed reaction is carried out at a temperature of 600 to 1300° C.

39. The method according to claim 26, wherein the single-stage, autothermal, uncatalyzed reaction is carried out for a period of 0.01 s to 1 s.

40. The method according to claim 26, further comprising fractionating or purifying the reaction gas.

41. The method according to claim 26, wherein at least one unsaturated hydrocarbon other an olefin is formed.

42. The method according to claim 41, wherein the starting mixture comprises at least one alkylaromatic and the at least one unsaturated hydrocarbon other than an olefin comprises a dealkylated aromatic.

43. The method according to claim 41, wherein the starting mixture comprises at least one alkane and the at least one unsaturated hydrocarbon other than an olefin comprises an alkyne.

44. A method comprising:
(a) providing a starting mixture comprising at least one alkylaromatic and at least one oxygen source, wherein the starting mixture has a fuel number of at least 4;
(b) heating the starting mixture to a temperature of 900 to 1250° C. and subjecting it to a single-stage, autothermal, uncatalyzed reaction for a period of 0.05 to 1 s to form a reaction gas; and
(c) subjecting the reaction gas to rapid cooling to form a dealkylated aromatic and synthesis gas.

45. A method comprising:
(a) providing a starting mixture comprising at least one alkane and at least one oxygen source, wherein the starting mixture has a fuel number of at least 4;
(b) heating the starting mixture to a temperature of 1150 to 1400° C. and subjecting it to a single-stage, autothermal, uncatalyzed reaction for a period of 0.01 to 1 s to form a reaction gas; and
(c) subjecting the reaction gas to rapid cooling to form an alkyne and synthesis gas.
